(19) United States
(12) Patent Application Publication
(10) Pub. No.: US 2022/0405243 A1
(43) Pub. Date: Dec. 22, 2022

(54) BATCHING OF METADATA UPDATES IN JOURNALED FILESYSTEMS USING LOGICAL METADATA UPDATE TRANSACTIONS

(71) Applicant: VMWARE, INC., Palo Alto, CA (US)

(72) Inventors: PRASANNA AITHAL, Bangalore (IN); SRINIVASA SHANTHARAM, Bangalore (IN); PRASAD RAO JANGAM, Palo Alto, CA (US); MAHESH HIREGOUDAR, Bangalore (IN); ROHAN PASALKAR, Palo Alto, CA (US); SRIKANTH MAHABALARAO, Bangalore (IN)

(21) Appl. No.: 17/403,922

(22) Filed: Aug. 17, 2021

(30) Foreign Application Priority Data
Jun. 17, 2021 (IN) 202141027146

(51) Int. Cl. G06F 16/16; G06F 16/18; G06F 16/17

(52) U.S. Cl. CPC G06F 16/164; G06F 16/1815; G06F 16/1727

(57) ABSTRACT

System and method for journaling metadata update transactions of file system operations use logical metadata update transactions to record metadata updates for a target file in response to file system operation requests at a file system of the system. A single physical metadata update transaction is generated by consolidating multiple logical metadata update transactions for the target file. The physical metadata update transaction is then written to a journal area of a physical storage.

### RELATED APPLICATION

Benefit is claimed under 35 U.S.C. 119(a)-(d) to Foreign Application Serial No. 202141027146 filed in India entitled “BATCHING OF METADATA UPDATES IN JOURNALED FILESYSTEMS USING LOGICAL METADATA UPDATE TRANSACTIONS”, on Jun. 17, 2021, by VMware, Inc., which is herein incorporated in its entirety by reference for all purposes.

### BACKGROUND

In a journaled file system, a serial log or journal of storage-related activities is maintained as metadata update transactions so that any lost data due to a crash can be recreated using the journal. Some workloads, such as first-writes on thin provisioned virtual disks, may be metadata intensive. Since the amount of journal space can be limited in a journaled file system, a bottleneck may occur under such workloads due to journaling. Thus, the amount of parallelism that can be achieved is reduced, which limits performance and scalability.

### BRIEF DESCRIPTION OF THE DRAWINGS

FIG. 1 is a block diagram of a computer system with a journaled file system that uses logical metadata update transactions in accordance with an embodiment of the invention

FIG. 2 is a flow diagram of a process of managing metadata updates of file system operations in the computer system of FIG. 1 in accordance with an embodiment of the invention.

FIG. 3 is a block diagram of a distributed computer system that uses a batched logical metadata update management technique in accordance with an embodiment of the invention.

FIG. 4 illustrate components of a journaled file system in each host computer in the distributed computer system of FIG. 3 in accordance with an embodiment of the invention.

FIG. 5 is a flow diagram of an operation executed by the journaled file system depicted in FIG. 4 to generate a logical metadata update transaction for resource allocation in accordance with an embodiment of the invention.

FIG. 6 is a flow diagram of an operation executed by the journaled file system depicted in FIG. 4 to generate a logical metadata update transaction for resource deallocation in accordance with an embodiment of the invention.

FIG. 7 is a flow diagram of an operation executed by the journaled file system depicted in FIG. 4 to consolidate multiple logical metadata update transactions for a target file for journaling in accordance with an embodiment of the invention.

FIG. 8 is a flow diagram of a computer-implemented method for journaling metadata update transactions of file system operations in a computer system in accordance with an embodiment of the invention.

Throughout the description, similar reference numbers may be used to identify similar elements.

### DETAILED DESCRIPTION

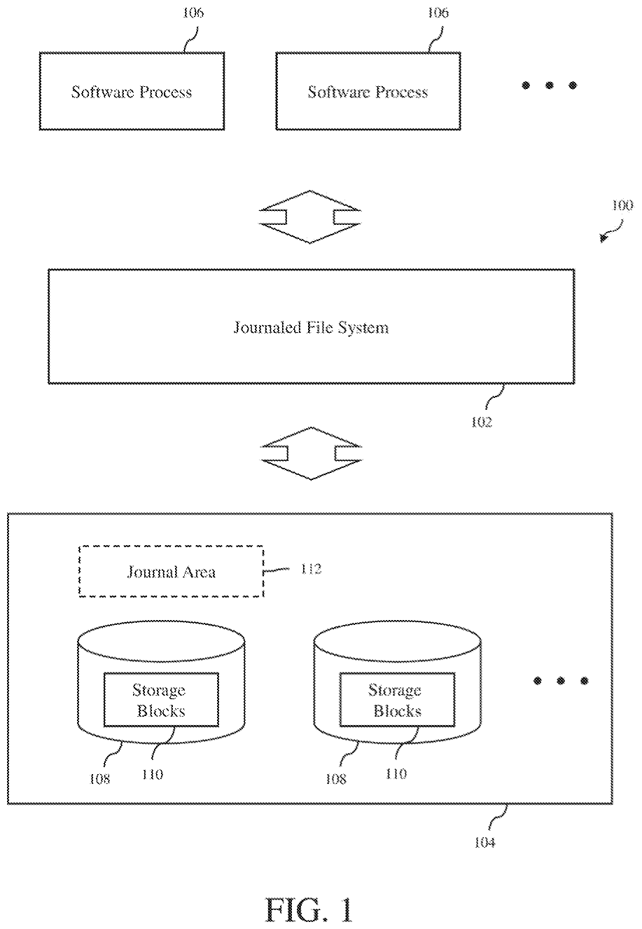

FIG. 1 depicts a computer system 100 in accordance with an embodiment of the invention. The computer system 100 is shown to include a journaled file system 102 and a storage system 104. Other components of the computer system that are commonly found in a conventional computer system, such as memory and one or more processors, are not shown in FIG. 1. The computer system 100 allows software processes 106 running on the computer system to perform storage-related or file system operations, such as writing and reading data of file system objects, e.g., directories, folders or files, which are stored in the storage system 104. These file system operations typically need to update metadata associated with data stored in the storage system 104, such as allocation or deallocation of storage resources in the storage system.

In a conventional journaled file system, metadata updates for file system operations are recorded in metadata update transactions as absolute values or images (e.g., sets of data, each of which may fit in a disk sector), which are written to a physical storage medium, e.g., a disk, in a journal area. These metadata update transactions can then get played to actual metadata locations on one or more storage devices by reading from the journal area and writing to the designated metadata locations. However, some file system workloads may be metadata intensive, which may overwhelm the journal area and cause a bottleneck. As explained below, the journaled file system 102 of the computer system 100 utilizes a technique to reduce the amount of journal space used to handle metadata updates, which increases performance and allows for scalability.

Turning back to FIG. 1, the software processes 106 can be any software program, applications or software routines that can run on one or more computer systems, which can be physical computers, virtual computers, such as VMware virtual machines, or a distributed computer system. The software processes 106 may initiate various storage-related or file system operations, such as read, write, delete and rename operations, for data stored or to be stored in the storage system 104, which are then managed by the file system 102.

The storage system 104 includes one or more computer data storage devices 108, which are used by the computer system 100 to store data, including metadata of file system objects and actual data of the file system objects. The data storage devices can be any type of non-volatile storage devices that are commonly used for data storage. As an example, the data storage devices may be, but not limited to, solid-state devices (SSDs), hard disks or a combination of the two. The storage space provide by the data storage devices may be divided into storage blocks 110, which may be disk blocks, disk sectors or other storage device sectors.

In an embodiment, the storage system 104 may be a local storage system of the computer system 100, such as hard drive disks in a personal computer system. In another embodiment, the storage system may be a remote storage system that can be accessed via a network, such as a network-attached storage (NAS). In still another embodiment, the storage system may be a distributed storage system such as a storage area network (SAN) or a virtual SAN. Depending on the embodiment, the storage system may include other components commonly found in those types of storage systems, such as network adapters, storage drivers and/or storage management servers. The storage system may be scalable, and thus, the number of data storage devices 108 included in the storage system can be changed as needed to increase or decrease the capacity of the storage system to support increase/decrease in workload. Consequently, the exact number of data storage devices included in the storage system can vary from one to hundreds or more.

The journaled file system 102 operates to present storage resources of the storage system 104 as one or more file system structures, which include hierarchies of file system objects, such as file system volumes, file directories/folders, and files, for shared use of the storage system. Thus, the file system organizes the storage resources of the storage system into the file system structures so that the software processes 106 can access the file system objects for various file system operations, such as creating file system objects, deleting file system objects, writing or storing file system objects, reading or retrieving file system objects and renaming file system objects.

The journaled file system 102 maintains storage metadata of actual data of file system objects stored in the storage system 104. As used herein, the actual data of file system objects stored in the storage system is content, such as the contents or actual data of files, and the storage metadata describes that content with respect to its characteristics and physical storage locations. Thus, the storage metadata is information that describes the actual stored data, such as names, file paths, modification dates and permissions. The storage metadata can also be stored in any other storage accessible by the file system. In a distributed file system architecture, the storage metadata may be stored in multiple metadata servers located at different storage locations.

In addition to actual data and metadata of the actual data, the file system 102 generates and manages metadata updates caused by file system operations, which may be requested by the software processes 106. These metadata updates, such as allocation and deallocation of blocks, are recorded by the file system in metadata update transactions using a journaling process. The metadata updates are needed when file system operations being executed by the file system require metadata changes. Similar to conventional journaled file systems, the file system 102 uses a journal area 112 in the storage system 104 to physically store the metadata update transactions of file system operations by writing the metadata update transactions to the journal area in one or more of the data storage devices 108 in the storage system 104. The metadata update transactions stored in the journal area 112 can be periodically played to store the metadata updates in other designated areas of the storage system 104, which would free up the journal space for more metadata update transactions.

However, rather than storing each metadata update transaction in the journal area 112, like in conventional journaled file systems, at least some of the metadata update transactions are consolidated by the file system 102 so that fewer metadata update transactions are written into the journal area 112 of the storage system 104. Thus, using the file system 102, potential bottleneck at the journal area 112 may be avoided, which can increase the performance of the computer system 100.

In the journaled file system 102, metadata update transactions are separated into two separate or distinct entities, logical metadata update transactions and physical metadata update transactions. Logical metadata update transactions are metadata update transactions that are stored temporarily in volatile memory of the computer system 100. Thus, logical metadata update transactions do not consume or occupy any space in the journal area 112. The logical metadata update transactions record metadata updates in a logical manner instead of absolute values or images. For example, when a metadata value “X” is getting updated from, say, 10 to 20, the logical metadata update transaction records this as “X increments by 10”. This logical way of representing metadata updates can be extended to typical file system operations such as “Allocating resource ‘A’ from a storage resource pool ‘X’ to file ‘Y’”, “Freeing resource ‘A’ from file ‘Y’ to a storage resource pool ‘X’”, etc. When multiple logical metadata update transactions relate to the same entity, such as a particular file or a particular storage resource pool, these logical metadata update transactions can get consolidated into a single physical metadata update transaction.

Physical metadata update transactions are metadata update transactions that get written into the journal area 112 in the storage system 104. Thus, physical metadata update transactions are similar to traditional metadata update transactions used in conventional journaled file systems. Similar to the traditional metadata update transactions written into a journal space, the physical metadata update transactions stored in the journal area 112 in the storage system 104 can be periodically played by the file system 102 to store the metadata updates in designated areas of the storage system 104 outside of the journal area, which would free up the journal space for more physical metadata update transactions.

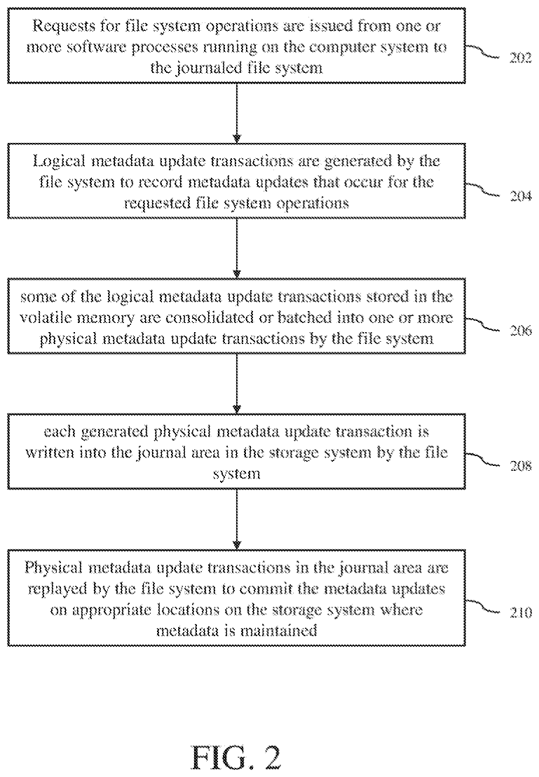

A process of managing metadata updates of file system operations in the computer system 100 in accordance with an embodiment of the invention is described with reference to a flow diagram of FIG. 2. The process begins at step 202, where one or more of the software processes 106 running on the computer system 100 issue requests for file system operations to the journaled file system 102. These file system operations include, but are not limited to, file create, file delete file open, file read, file write, file append, file seek, file get and file set operations.

Next, at step 204, logical metadata update transactions are generated by the file system 102 to record metadata updates that occur for the requested file system operations. These logical metadata update transactions may include, for example, allocation and deallocation of blocks for files. In some embodiments, the logical metadata update transactions are stored in the volatile memory of the computer system 100. Since the logical metadata update transactions are stored in memory, the logical metadata update transactions do not take up any space in the journal area 112.

Next, at step 206, some of the logical metadata update transactions stored in the volatile memory are consolidated or batched into one or more physical metadata update transactions by the file system 102. The logical metadata update transactions that are batched into a single physical metadata update transaction are logical metadata update transactions that involve updates to the same storage entity, such as a file or a defined storage resource. For example, if multiple logical metadata update transactions represent increments or decrements to the same storage entity, such as a file, then those logical metadata update transactions can be batched into a single physical metadata update transaction.

Next, at step 208, each generated physical metadata update transaction is written into the journal area 112 in the storage system 104 by the file system 102. In an embodiment, the physical metadata update transactions may be formatted into a standardized structure. These physical metadata update transactions are similar to metadata update transactions commonly found in traditional journaled file systems, where there are only one type of metadata update transactions, which are written into a journal area on a persistent storage.

Next, at step 210, the physical metadata update transactions in the journal area 112 are played by the file system 102 to commit the metadata updates on appropriate locations on the storage system where metadata is maintained. After the physical metadata update transactions in the journal area are played, the physical metadata update transactions are removed from the journal area so that there is more room in the journal area for new physical metadata update transactions.

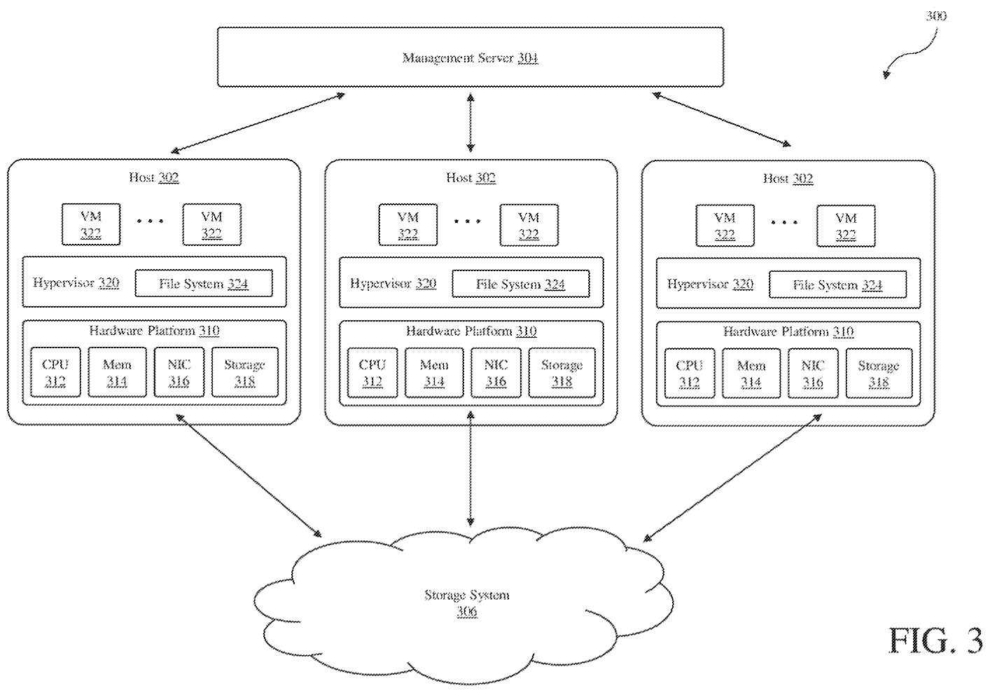

In some embodiments, the batched logical metadata update management technique described above may be employed in a distributed computer system. Turning now to FIG. 3, a distributed computer system 300 that uses the batched logical metadata update management technique in accordance with an embodiment of the invention is illustrated. As shown in FIG. 3, the distributed computing system 300 includes a number of host computers 302, a management server 304 and a storage system 306, which may be similar to the storage system 104 depicted in FIG. 1.

Each of the host computers 302 in the distributed computer system 300 is configured to support a number of virtual computing instances. As used herein, the term “virtual computing instance” refers to any software processing entity that can run on a computer system, such as a software application, a software process, a virtual machine or a virtual container. A virtual machine is an emulation of a physical computer system in the form of a software computer that, like a physical computer, can run an operating system and applications. A virtual machine may be comprised of a set of specification and configuration files and is backed by the physical resources of the physical host computer. A virtual machine may have virtual devices that provide the same functionality as physical hardware and have additional benefits in terms of portability, manageability, and security. An example of a virtual machine is the virtual machine created using VMware vSphere® solution made commercially available from VMware, Inc of Palo Alto, Calif. A virtual container is a package that relies on virtual isolation to deploy and run applications that access a shared operating system (OS) kernel. An example of a virtual container is the virtual container created using a Docker engine made available by Docker, Inc. In this disclosure, the virtual computing instances will be described as being virtual machines, although embodiments of the invention described herein are not limited to virtual machines (VMs).

As shown in FIG. 3, each of the host computers 302 includes a physical hardware platform 310, which includes at least one or more processors 312, one or more system memories 314, a network interface 316 and a storage 318. Each processor 312 can be any type of a processor, such as a central processing unit (CPU) commonly found in a server computer. Each system memory 314, which may be random access memory (RAM), is the volatile memory of the host computer. The network interface 316 is any interface that allows the host computer to communicate with other devices through one or more computer networks. As an example, the network interface 316 may be a network interface controller (NIC). The storage 318 can be any type of non-volatile computer storage with one or more local storage devices, such as solid-state devices (SSDs) and hard disks. In an embodiment, the storages 318 of the different host computers 302 may be used to form a virtual storage array network (VSAN), which may be the storage system 306 of the distributed computer system 300.

Each host computer 302 further includes a virtualization software 320 running directly on the hardware platform 310 or on an operation system (OS) of the host computer. The virtualization software 320 can support one or more VCIs 322, which are VMs in the illustrated embodiment. In addition, the virtualization software 320 can deploy or create VCIs on demand. Although the virtualization software 320 may support different types of VCIs, the virtualization software 320 is described herein as being a hypervisor, which enables sharing of the hardware resources of the host computer by the VMs 322 that are hosted by the hypervisor. One example of a hypervisor that may be used in an embodiment described herein is a VMware ESXi™ hypervisor provided as part of the VMware vSphere® solution made commercially available from VMware, Inc. of Palo Alto, Calif.

The hypervisor 320 in each host computer 302 provides a device driver layer configured to map physical resources of the hardware platform 310 to “virtual” resources of each VM supported by the hypervisor such that each VM has its own corresponding virtual hardware platform. Each such virtual hardware platform provides emulated or virtualized hardware (e.g., memory, processor, storage, network interface, etc.) that may function as an equivalent to conventional hardware architecture for its corresponding VM.

With the support of the hypervisor 320, the VMs 322 in each host computer 302 provide isolated execution spaces for guest software. Each VM may include a guest operating system (OS) and one or more guest applications. The guest OS manages virtual hardware resources made available to the corresponding VM by the hypervisor 320, and, among other things, the guest OS forms a software platform on top of which the guest applications run.

The hypervisor 320 in each host computer 302 includes a journaled file system 324, which uses the batched logical metadata update management technique described above with respect to the journaled file system 102 in the computer system 100. Thus, the file system 324 handles file system operations in the respective host computer 302 and generates logical metadata update transactions for the file system operations, which can be batched into physical metadata update transactions, as explained above.

The management server 304 of the distributed computing system 300 operates to manage and monitor the host computers 302. The management server 304 may be configured to monitor the current configurations of the host computers 302 and any VCIs, e.g., VMs 322, running on the host computers. The monitored configurations may include hardware configuration of each of the host computers 302 and software configurations of each of the host computers. The monitored configurations may also include VCI hosting information, i.e., which VCIs are hosted or running on which host computers 302. The monitored configurations may also include information regarding the VCIs running on the different host computers 302.

In some embodiments, the management server 304 may be a physical computer. In other embodiments, the management server may be implemented as one or more software programs running on one or more physical computers, such as the host computers 302, or running on one or more VCIs, which may be hosted on any of the host computers. In an implementation, the management server 304 is a VMware vCenter™ server with at least some of the features available for such a server.

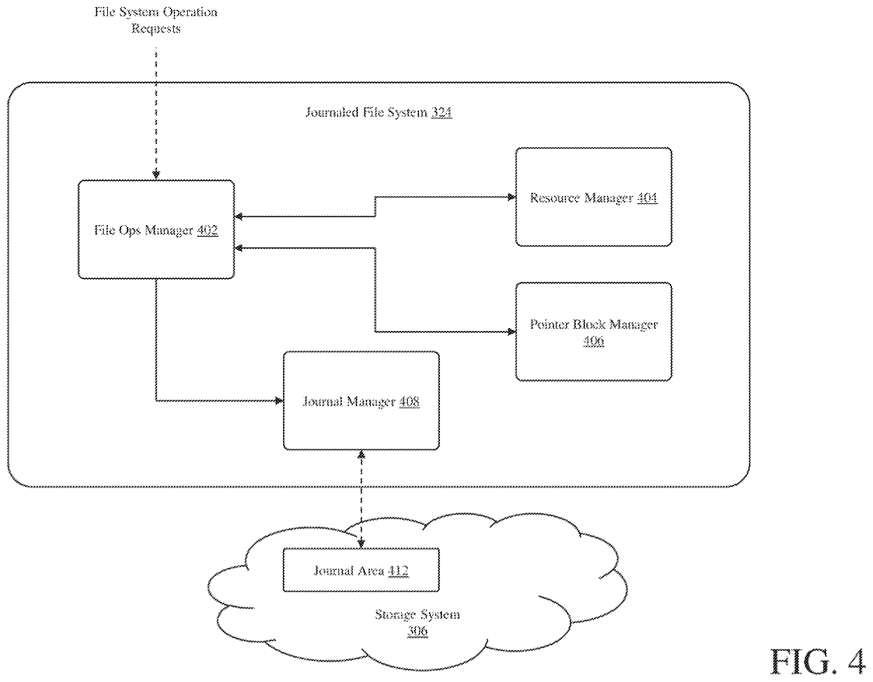

Turning now to FIG. 4, components of the journaled file system 324 in each of the host computers 302 in accordance with an embodiment of the invention are illustrated. As shown in FIG. 4, the file system 324 includes a file ops manager 402, a resource manager 404, a pointer block manager 406 and a journal manager 408, which operate to manage logical and physical metadata update transactions in response to file system operation requests. Although not illustrated, the file system 324 may include other components that handle file system operations, which may be found in other conventional file systems.

The file ops manager 402 operates to receive and process requests for various file system operations, such as file open/close operations, file input/output (IO) control operations, and file IO operations (i.e., reads and writes). In addition, the file ops manager manages metadata of files (“file metadata”) being supported by the file system 324. File metadata is analogous to inode in a Unix® filesystem parlance. File metadata has information about each file, such as the length of the file, the number of blocks allocated to the file, and an array holding addressing information to blocks that make up the file. As with a Unix® file system, the blocks for a file can be directly or indirectly addressed. The files managed by the file system 324 may include virtual machine disk files, which may be thin provisioned virtual disk files, lazy zeroed thick (LZT) virtual disk files and/or eager zeroed thick (EZT) virtual disk files.

The resource manager 404 operates to manage the storage resources of a storage system associated with the file system 324, which in the illustrated embodiment is the storage system 306. The resource manager can allocate and free or deallocate storage resources for files, as well as synchronize resource allocation among different threads and/or contexts. In addition, the resource manager manages metadata of storage resources (“resource metadata”), for example, metadata of storage resource entity, such as resource cluster. In some embodiments, the file system 324 uses datastores, such as Virtual Machine File System (VMFS) datastores. The free space of a VMFS datastore is hierarchically represented as resource clusters. In a particular implementation, the VMFS block size is 1 MB and the free space is made up of several 1 MB “resources”. A grouping of resources is called a resource cluster, which may be formed by 512 consecutive resources, where these resources are numbered 0-511 within the cluster. In this embodiment, “n” number of consecutive resource clusters make up the entire free space, where these free space resource clusters are numbered 0-n. Resource cluster metadata identifies the location of the resource cluster in the free space, the number of free resources within it and a bitmap indicating the positions of the said free resources within it. Any particular resource can be identified by the tuple of (resourceClusterNumber, resourceNumber).

The pointer block manager 406 operates to manage metadata of pointer blocks (PBs) and address resolution. In some instances, a file may have indirectly addressed blocks. In such a case, the file metadata points to PBs that in turn point to data blocks. Metadata of PBs (“PB metadata”) contains information regarding PBs.

As explained further below, the file ops manager 402, the resource manager 404 and/or the pointe block manager 406 update their respective metadata when needed. These metadata updates are recorded in logical metadate update transactions, which means that these transactions are not persistently stored, i.e., not written to a persistent storage, such as a physical disk. Rather, these logical metadate update transactions stored in memory and then batched into smaller number of physical metadate update transactions, which are used for journaling.

The journal manager 408 operates to manage a journal area 412 in the storage system 306 for the file system 324. In addition, the journal manager consolidates logical metadate update transactions with metadata updates executed by the file ops manager 402, the resource manager 404 and/or the pointe block manager 406 into fewer physical metadate update transactions. That is, multiple logical metadate update transactions are consolidated into a single physical metadate update transaction, which is then committed or written to the journal area 412. The journal manager also can execute a play of the physical metadate update transactions to write the metadata updates to designated metadata locations, which are outside of the journal area 412, in the storage system 306.

In the journaled file system 324, updates to the file metadata, the resource metadata and the PB metadata are implemented as logical updates, which means that these metadata updates are not persistently stored, i.e., not written to a persistent storage, such as a physical disk. Updates to various fields for the different metadata can logically represented. For an integer (count) type of field, the logical update can be an increment or a decrement. For a bitmap type of field, the logical update can be set or unset at specific bit offsets in a bitmap. For a value (which may be a string), the logical update can be “assign”. These logical updates are summarized in the following table:

| Type of field | Type of logical update | Comments |
|---|---|---|
| Integer (count) | Increment/Decrement | |
| Bitmap | Set/Unset at specific | |
| | bit offsets | |
| Value | Assign | These updates are |
| | | idempotent |

Referring to the table above, the process of allocating a resource “x” from a resource cluster “y”, which is an update of resource cluster metadata for allocation for a particular resource, can be logically defined as:

UpdateRCMetaForAlloc(resourceClusterNumber, resourceNumber), which involves performing the following steps on resource cluster metadata of “resourceClusterNumber”
Unset bitmap at bit offset “resourceNumber”
Decrement “freeResource” integer count
Decrement “pendingUnmaps” integer count
Increment “writer generation count” integer
Assign current host universally unique identifier (UUID) to indicate this host recently updated this metadata.

Similarly, the process of freeing a resource “x” from a resource cluster “y”, which is an update of resource cluster metadata for deallocation for a particular resource, can be logically defined as:

UpdateRCMetaForFree(resourceClusterNumber, resourceNumber), which involves performing the following steps on resource cluster metadata of “resourceClusterNumber”
Set bitmap at bit offset “resourceNumber”
Increment “freeResource” integer count
Increment “pendingUnmaps” integer count
Increment “writer generation count” integer
Assign current host UUID to indicate this host recently updated this metadata

An example of how a set of logical metadate update transactions get batched is now described. In this example, it is assumed that there are 16 resources per cluster for simplicity. The initial state of resource cluster metadata for a target resource cluster, where all the resource of the cluster are free, can be represented as follows:

```
{
  bitmap = 1111111111111111,
  freeResources = 16,
  pendingUnmaps = 16,
  writer.gen = 0,
  writer.UUID = 0000000000000000
}
```

The following logical metadate update transactions are executed on the target resource cluster:
a. Allocate resource 0
b. Allocate resource 1
c. Allocate resource 2
d. Allocate resource 3
e. Free resource 0
f. Allocate resource 4
g. Free resource 1
h. Allocate resource 5

As a result of these logical metadate update transactions, resources 0 and 1 have now been freed or deallocated, and resources 2, 3, 4 and 5 have been allocated. Batching or consolidation of these logical metadate update transactions will result in the following final resource cluster metadata image:

```
{
  bitmap = 1100001111111111
  freeResources = 12
  pendingUnmaps = 12
  writer.gen = 8
  writer.UUID = <current host uuid>
}
```

This final resource cluster metadata image may be included in a single physical metadate update transaction, which includes metadata updates from all eight (8) logical metadata update transactions. The physical metadate update transaction reflects a result of a sequence of increments and decrements specified in the eight (8) logical metadata update transactions. For example, the final “freeResource” integer count reflects a result of a sequence of increments and decrements specified in the eight (8) logical metadata update transactions from the initial value of 16, which can be expressed as 16+(−1)+(−1)+(−1)+(−1)+(1)+(−1)+(1)+(−1)=12. The physical metadate update transaction also reflects a result of a sequence of sets and unsets at specific bit offsets in the bitmap specified in the eight (8) logical metadata update transactions. Specifically, the final bit map of bitmap=1100001111111111 reflects a result of a sequence of sets and unsets at specific bit offsets in the bitmap specified in the eight logical metadata update transactions from the initial bitmap of bitmap=1111111111111111.

Thus, rather than journaling eight (8) physical metadate update transactions in the journal area 412, a single batched physical metadate update transaction can be journaled, which can reduce or eliminate a bottleneck caused by lack of space in the journal area. Thus, performance of the host computer can be significantly improved when certain types of file system operations are being executed by the journaled file system 324.

The batching of logical metadata updates is further described using an example of a random write workload running on a thin provisioned virtual disk residing on a VMFS datastore. Thin provisioned virtual disks are backed by files that are completely empty (no blocks allocated). As writes happen, blocks are allocated. These block allocations need to update the resource metadata to mark resource as allocated and the file metadata to record the resource allocated from a resource cluster in the file's block address array. Typically, to maintain locality of reference, resources are continuously allocated from the same/nearby resource clusters for a particular file, as much as possible. This means that ongoing concurrent writes will need to update the same resource metadata until that resource cluster is completely consumed. Using a conventional journaled file system, a metadata update transaction must be generated and physically written to a journal area for each write. However, using the journal file system 324 that creates logical metadata update transactions for the writes that are consolidated into fewer physical logical metadata update transactions, the journal space is significantly saved, which can improve the overall performance of the computer system employing the file system.

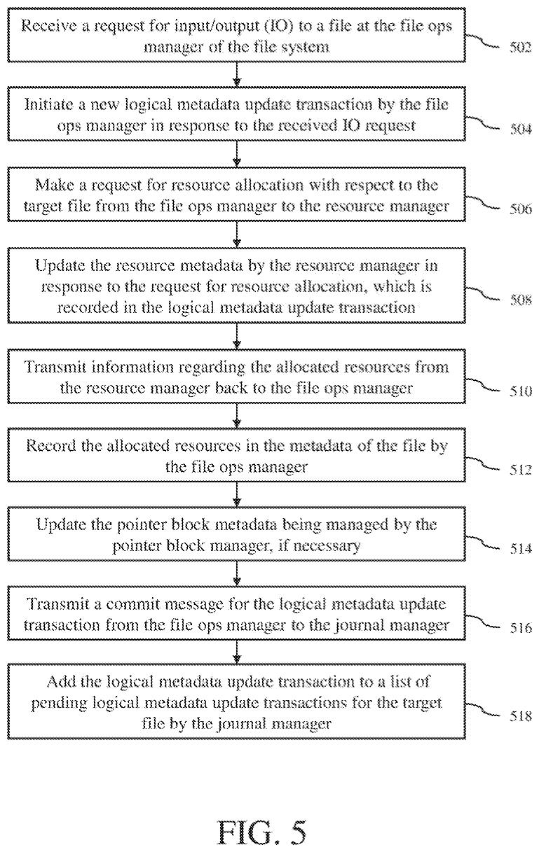

An operation executed by the journaled file system 324 in one of the host computers 302 to generate a logical metadata update transaction for resource allocation in accordance with an embodiment is described with reference to a process flow diagram of FIG. 5. The operation begins at step 502, where a request for input/output (TO) to a file is received at the file ops manager 402 of the file system 324. The IO request may have originated from any software process running on the host computer, such as a VM running on the host computer via a virtual Small Computer System Interface (SCSI) provided by the hypervisor 320 of the host computer. For certain 10 operations, such as first-writes to thinly provisioned virtual disks, storage resources must be allocated, and thus, require journaling of metadata updates. It is assumed here that the received IO request requires resource allocation, i.e., allocation of storage blocks of one or more physical storage devices in the storage system 306.

Next, at step 504, a new logical metadata update transaction is initiated by the file ops manager 402 in response to the received IO request that requires resource allocation. The new logical metadata update transaction will be used to record all the logical metadata updates involved in the resource allocation.

Next, at step 506, a request for resource allocation with respect to the target file is made from the file ops manager 402 to the resource manager 404. In an embodiment, the request for resource allocation specifies the amount of storage resources or blocks that are needed. In some embodiments, the logical metadata update transaction is transmitted with the request for resource allocation.

Next, at step 508, the resource metadata is updated by the resource manager 404 in response to the request for resource allocation, which is recorded in the logical metadata update transaction. In an embodiment, the resource metadata is a resource cluster metadata. In this embodiment, the UpdateRCMetaForAlloc(resourceClusterNumber, resourceNumber) operation, which was described above, is executed for each particular resource.

Next, at step 510, information regarding the allocated resources is transmitted from the resource manager 404 back to the file ops manager 402. In some embodiments, the logical metadata update transaction is transmitted with the allocated resource information.

Next, at step 512, the allocated resources are recorded in the metadata of the file by the file ops manager 402. Thus, the file metadata is updated to reflect the allocated resources. This file metadata data is also recorded in the logical metadata update transaction.

Next, at optional step 514, the pointer block metadata being managed by the pointer block manager 406 is updated, if necessary. This step is executed when the allocated resources involve any pointer blocks associated with the target file. In some embodiments, the pointer block metadata is updated by the pointer block manager 406 in response to a request from the file ops manager 402. The update to the pointer block metadata is then recorded in the logical metadata update transaction. In some embodiments, the logical metadata update transaction is transmitted to the pointer block manager 406 from the file ops manager 402 to record the pointer block metadata update and returned back to the file ops manager.

Next, at step 516, a commit message for the logical metadata update transaction is transmitted from the file ops manager 402 to the journal manager 408. The logical metadata update transaction can now be committed since all the different logical metadata updates for the IO request have been recorded in the logical metadata update transaction. In an embodiment, the commit message may include the logical metadata update transaction.

Next, at step 518, the logical metadata update transaction is added to a list of pending logical metadata update transactions for the target file by the journal manager 408. The list of pending logical metadata update transactions for the target file may be one of many lists of pending logical metadata update transactions for different files. In an embodiment, the lists of pending logical metadata update transactions are stored in memory, i.e., the volatile system memory of the host computer.

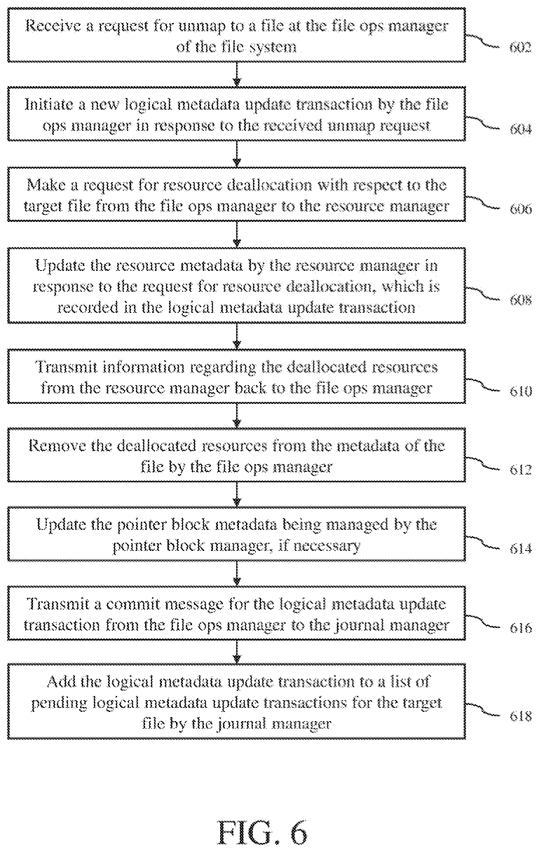

An operation executed by the journaled file system 324 in one of the host computers 302 to generate a logical metadata update transaction for resource deallocation in accordance with an embodiment is described with reference to a process flow diagram of FIG. 6. The operation begins at step 602, where a request for unmap to a file is received at the file ops manager 402 of the file system 324. The unmap request have originated from any software process running on the host computer, such as a VM running on the host computer via a virtual SCSI provided by the hypervisor 320 of the host computer.

Next, at step 604, a new logical metadata update transaction is initiated by the file ops manager 402 in response to the received unmap request that requires resource deallocation, i.e., freeing of storage resources. The new logical metadata update transaction will be used to record all the logical metadata updates involved in the resource deallocation.

Next, at step 606, a request for resource deallocation with respect to the target file is made from the file ops manager 402 to the resource manager 404. In an embodiment, the request for resource deallocation specifies the amount of storage resources or blocks that are to be freed. In some embodiments, the logical metadata update transaction is transmitted with the request for resource deallocation.

Next, at step 608, the resource metadata is updated by the resource manager 404 in response to the request for resource deallocation, which is recorded in the logical metadata update transaction. In an embodiment, the resource metadata is a resource cluster metadata. In this embodiment, the UpdateRCMetaForFree(resourceClusterNumber, resourceNumber) operation, which was described above, is executed for each particular resource.

Next, at step 610, information regarding the deallocated resources is transmitted from the resource manager 404 back to the file ops manager 402. In some embodiments, the logical metadata update transaction is transmitted with the deallocated resource information.

Next, at step 612, the deallocated resources are removed or deleted from the metadata of the file by the file ops manager. Thus, the file metadata is updated to reflect the deallocated resources. This file metadata data is also recorded in the logical metadata update transaction.

Next, at optional step 614, the pointer block metadata being managed by the pointer block manager 406 is updated, if necessary. This step is executed when the deallocated resources involve any pointer blocks associated with the target file. In some embodiments, the pointer block metadata is updated by the pointer block manager 406 in response to a request from the file ops manager 402. The update to the pointer block metadata is then recorded in the logical metadata update transaction. In some embodiments, the logical metadata update transaction is transmitted to the pointer block manager 406 from the file ops manager 402 to record the pointer block metadata update and returned back to the file ops manager.

Next, at step 616, a commit message for the logical metadata update transaction is transmitted from the file ops manager 402 to the journal manager 408. The logical metadata update transaction can now be committed since all the different logical metadata updates for the unmap request have been recorded in the logical metadata update transaction. In an embodiment, the commit message may include the logical metadata update transaction.

Next, at step 618, the logical metadata update transaction is added to a list of pending logical metadata update transactions for the target file by the journal manager 408. The logical metadata update transactions for the target file in the list may include logical metadata update transaction for resource allocation as well as logical metadata update transaction for resource deallocation.

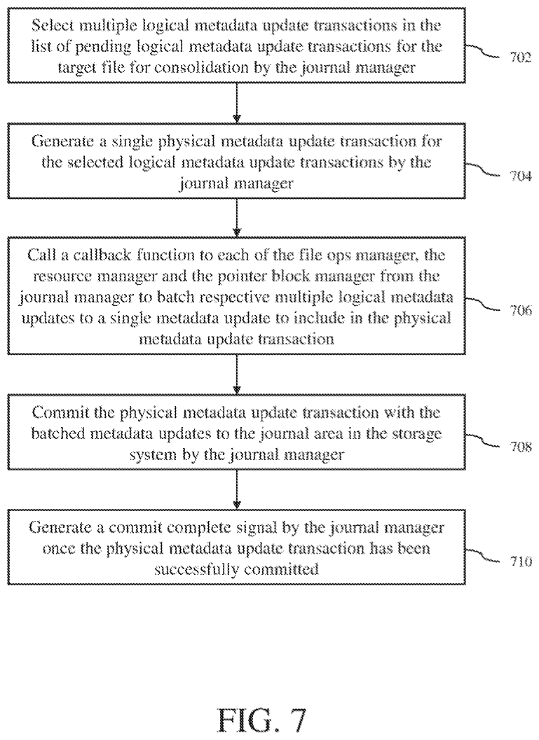

An operation executed by the journaled file system 324 in one of the host computers 302 to consolidate multiple logical metadata update transactions for a target file for journaling in accordance with an embodiment is described with reference to a process flow diagram of FIG. 7. This operation may be executed for the target file based on one or more criteria, such as a predefined schedule or the length of the list of logical metadata update transactions for the target file.

The operation begins at step 702, where multiple logical metadata update transactions in the list of pending logical metadata update transactions for the target file are selected for consolidation by the journal manager 408. The number of logical metadata update transactions that are selected may vary depending on the limits on the journal area 412. Thus, the number of logical metadata update transactions in the list that are selected may be smaller than the number of all logical metadata update transactions current in the list for the target file.

Next, at step 704, a single physical metadata update transaction for the target file is generated for the selected logical metadata update transactions by the journal manager 408. The single physical metadata update transaction is used to consolidate the selected logical metadata updates transactions into a single transaction.

Next, at step 706, a callback function is called to each of the file ops manager 402, the resource manager 404 and the pointer block manager 406 from the journal manager 408 to batch respective multiple logical metadata updates to a single metadata update to include in the physical metadata update transaction. In an embodiment, the batched metadata update may be in the form of an image, which includes data for a single sector of a physical storage medium, e.g., a disk. Thus, all the batched metadata updates from the file ops manager 402, the resource manager 404 and the pointer block manager 406 may be included in the single physical metadata update transaction.

Next, at step 708, the physical metadata update transaction with the batched metadata updates produced by the file ops manager 402, the resource manager 404 and/or the pointer block manager 406 is committed to the journal area 412 in the storage system 306 by the journal manager 408. This step involves writing the physical metadata update transaction in the journal area 412 on one or more physical storage media, e.g., disks, of the storage system 306.

Next, at step 710, a commit complete signal is generated by the journal manager 408 once the physical metadata update transaction has been successfully committed, i.e., successfully written into the journal area 412. The commit complete signal may be transmitted to the entity that made the IO request, e.g., a VM running on the host computer.

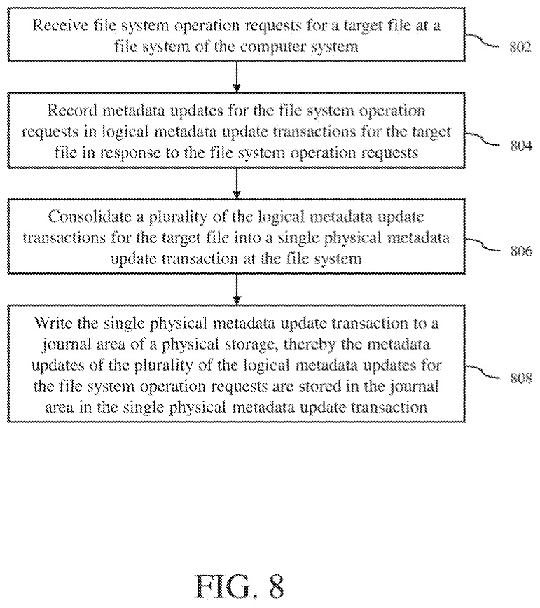

A computer-implemented method for journaling metadata update transactions of file system operations in a computer system, such as the computer system 100 or one of the host computers 302, in accordance with an embodiment of the invention is described with reference to a flow diagram of FIG. 8. At block 802, file system operation requests for a target file are received at a file system of the computer system. At block 804, metadata updates for the file system operation requests are recorded in logical metadata update transactions for the target file in response to the file system operation requests. At block 806, a plurality of the logical metadata update transactions for the target file is consolidated into a single physical metadata update transaction at the file system. At block 808, the single physical metadata update transaction is written to a journal area of a physical storage, thereby the metadata updates of the plurality of the logical metadata updates for the file system operation requests are stored in the journal area in the single physical metadata update transaction.

The components of the embodiments as generally described in this document and illustrated in the appended figures could be arranged and designed in a wide variety of different configurations. Thus, the detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid-state memory, non-volatile memory, NVMe device, persistent memory, magnetic tape, a removable computer diskette, a random-access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for journaling metadata update transactions of file system operations in a computer system, the method comprising:
receiving file system operation requests for a target file at a file system of the computer system;
recording metadata updates for the file system operation requests in logical metadata update transactions for the target file in response to the file system operation requests;
consolidating a plurality of the logical metadata update transactions for the target file into a single physical metadata update transaction at the file system; and
writing the single physical metadata update transaction to a journal area of a physical storage, thereby the metadata updates of the plurality of the logical metadata updates for the file system operation requests are stored in the journal area in the single physical metadata update transaction.

2. The method of claim 1, wherein the plurality of the logical metadata update transactions are stored in volatile memory of the computer system by the file system.

3. The method of claim 1, wherein the logical metadata update transactions include metadata update of an increment or a decrement for a count type of field.

4. The method of claim 3, wherein the single physical metadata update transaction reflects a result of a sequence of increments and/or decrements specified in the logical metadata update transactions.

5. The method of claim 1, wherein the logical metadata update transactions include a metadata update of set or unset at specific bit offsets in a bitmap.

6. The method of claim 5, wherein the single physical metadata update transaction reflects a result of a sequence of sets and/or unsets at specific bit offsets specified in the logical metadata update transactions.

7. The method of claim 1, wherein the logical metadata update transactions include metadata updates for storage block allocation and storage block deallocation.

8. The method of claim 1, wherein the target file is a thin provisioned virtual disk file for a virtual machine running on the computer system.

9. A non-transitory computer-readable storage medium containing program instructions for journaling metadata update transactions of file system operations in a computer system, wherein execution of the program instructions by one or more processors of a computer causes the one or more processors to perform steps comprising:
receiving file system operation requests for a target file at a file system of the computer system;
recording metadata updates for the file system operation requests in logical metadata update transactions for the target file in response to the file system operation requests;
consolidating a plurality of the logical metadata update transactions for the target file into a single physical metadata update transaction at the file system; and
writing the single physical metadata update transaction to a journal area of a physical storage, thereby the metadata updates of the plurality of the logical metadata updates for the file system operation requests are stored in the journal area in the single physical metadata update transaction.

10. The non-transitory computer-readable storage medium of claim 9, wherein the plurality of the logical metadata update transactions are stored in volatile memory of the computer system by the file system.

11. The non-transitory computer-readable storage medium of claim 9, wherein the logical metadata update transactions include metadata update of an increment or a decrement for a count type of field.

12. The non-transitory computer-readable storage medium of claim 11, wherein the single physical metadata update transaction reflects a result of a sequence of increments and/or decrements specified in the logical metadata update transactions.

13. The non-transitory computer-readable storage medium of claim 9, wherein the logical metadata update transactions include a metadata update of set or unset at specific bit offsets in a bitmap.

14. The non-transitory computer-readable storage medium of claim 13, wherein the single physical metadata update transaction reflects a result of a sequence of sets and/or unsets at specific bit offsets specified in the logical metadata update transactions.

15. The non-transitory computer-readable storage medium of claim 9, wherein the logical metadata update transactions include metadata updates for storage block allocation and storage block deallocation.

16. The non-transitory computer-readable storage medium of claim 9, wherein the target file is a thin provisioned virtual disk file for a virtual machine running on the computer system.

17. A system comprising:
memory; and
at least one processor configured to:
receive file system operation requests for a target file at a file system of the system;
record metadata updates for the file system operation requests in logical metadata update transactions for the target file in response to the file system operation requests;
consolidate a plurality of the logical metadata update transactions for the target file into a single physical metadata update transaction at the file system; and
write the single physical metadata update transaction to a journal area of a physical storage, thereby the metadata updates of the plurality of the logical metadata updates for the file system operation requests are stored in the journal area in the single physical metadata update transaction.

18. The system of claim 17, wherein the plurality of the logical metadata update transactions are stored in volatile memory of the system by the file system.

19. The system of claim 17, wherein the logical metadata update transactions include metadata update of an increment or a decrement for a count type of field.

20. The system of claim 17, wherein the logical metadata update transactions include a metadata update of set or unset at specific bit offsets in a bitmap.
